(19) United States
(12) Patent Application Publication
(10) Pub. No.: US 2020/0134959 A1
(43) Pub. Date: Apr. 30, 2020

(54) METHOD AND DEVICE FOR SELF-SERVICE FOOD DISTRIBUTION

(71) Applicant: John Lundin, Baton Rouge, LA (US)

(72) Inventor: John Lundin, Baton Rouge, LA (US)

(21) Appl. No.: 16/670,474

(22) Filed: Oct. 31, 2019

Related U.S. Application Data
(60) Provisional application No. 62/753,626, filed on Oct. 31, 2018.

(51) Int. Cl. G07F 11/00; A47J 39/00; G06Q 30/06; G06Q 20/32

(52) U.S. Cl. CPC G07F 11/00; G06Q 20/322; G06Q 30/0635; A47J 39/006

(57) ABSTRACT

A food distribution system comprising an electronic locking food storage device, wherein users interact with a software application to purchase food items from the system, track their orders, and can view multiple container systems and their locations when selecting items to purchase. Controllers and stockers of the food sales system can use the application to remotely lock and control the food sales system, monitor inventory, and review sales data from the purchases.

### CROSS REFERENCE TO RELATED APPLICATION

This application claims priority to U.S. Provisional Application No. 62/753,626, filed on Oct. 31, 2018, titled “METHOD AND DEVICE FOR SELF-SERVICE FOOD DISTRIBUTION.”

### STATEMENT REGARDING FEDERALLY SPONSORED RESEARCH OR DEVELOPMENT

Not applicable.

### REFERENCE TO A “SEQUENCE LISTING”, A TABLE, OR COMPUTER PROGRAM

Not applicable.

### FIELD OF THE INVENTION

This invention generally relates to the field of food distribution through self-serve appliances (i.e., refrigerators). More specifically, this invention relates to the field of using smart phone applications to operate self-service refrigerators that distribute food products that are purchased using the smart phone application.

### BACKGROUND OF THE INVENTION

Meal planning and home cooked meals play an important role in avoiding excessive costly restaurant meals. For a plurality of reasons, many people struggle with meal planning and advanced meal preparation. People frequently work long hours, leaving very little time in the day to prepare meals. Many people are also inexperienced with cooking, are not confident in their cooking skills, or simply do not like to cook. And others find it difficult to cook just for one or two people. All of these difficulties and others can lead to overspending on take-out food and/or overeating calorie-dense foods.

A number of solutions have been developed over the years. Some food preparation services offer microwaveable meals in grocery stores. However, because the meals are frozen for extended periods of time, the meal quality frequently suffers. Some food preparation services offer pre-prepared meals, but coordinating distribution of the meals through delivery or pick-up can frustrate any convenience offered. Many chefs that would like to distribute pre-prepared meals are small-production businesses, and thus lack a consistent physical presence where they could distribute the meals.

The device and method disclosed herein resolves these issues, by providing a way for busy individuals to conveniently access pre-prepared quality meals. The disclosure alleviates delivery issues, and also allows small-production chefs the opportunity to circulate their products in the marketplace without the need for a storefront or physical location.

### SUMMARY OF THE INVENTION

The disclosed method and device solves the problem of access to healthy meals for individuals that are time consumed, yet health conscious. The invention places technology-based refrigeration or non-refrigeration food units (“unit”) secured by a smart lock at the convenience of consumers on the go. The smart lock is connected to a mobile application to allow users to view inventory in each cooler and make purchases from their phone or other enabled device. Once the meal is purchased, the user will receive an access code that the user scans to unlock the unit.

Because no sales or other monitoring personnel are required, the transaction can be completed by the user at any time of day or night. In one application, though there are many, the invention provides healthy meals at any hour of the day to 24 hour gyms or other workout facilities.

In one or more embodiments, the inventive units and services are available to be rented and/or purchased, and stocked by already established meal prep and/or food manufacturers, and set up for distribution at pre-approved locations. The stocking and selling of the products may also be prescreened and managed by a third party administrator. The third party administrator may also have access to the unit remotely.

For example, in one embodiment of the invention, Company A desires to obtain the invention to be placed at Company A's workout facility. Before a unit is placed at Company A's workout facility, a third party administrator would screen Company A and its workout facility to make sure both meet the requirements for the inventive unit and services. The third party administrator would then set up the unit and services for that location and let Food Service Company A know when to stock. Once the last day of the shelf life is reached, the third party administrator would be notified, and if the food was not restocked by beginning of business the following day, then administrator would shut the unit down remotely. This adds an extra lawyer of safety and food protection for the user.

### DETAILED DESCRIPTION OF THE INVENTION

Herein disclosed is a system and method for securing food items in a food-storage device, in the preferred embodiment a refrigerator or freezer (“fridge”), and making the food items available only to those individuals who use the system's mobile application to pay for one or more items in the container. The system is generally composed of two subsystems: (1) the food storage system; and (2) the application. It should be understood that the application, which in the preferred embodiment comprises a software application operated on a user's mobile device, could also be a web-based application or other electronic mechanism that can perform similar functions. The applicant's decision to refer to the application as an “application” shall not be interpreted to exclude non-mobile devices and software.

For the food storage system, the system comprises a container for storing food and a locking mechanism. The locking mechanism is a physical device that, in the preferred embodiment, consists of two sections, wherein one section is secured to the door of the container and the other section is secured to the body of the container. Those having skill in the art will recognize that other locking mechanisms could be implemented with similar results, so nothing in this disclosure shall be interpreted to limit the locking mechanism to that described as the preferred embodiment. For the preferred lock, the lock is secured when the two sections of the lock come together and are connected. The lock comprises functionality to detect when the container has closed, and the lock will lock itself automatically when it detects the container is closed.

The locking mechanism further comprises hardware and software components to allow it to wireless connect to the internet for proper integration and operation with the mobile app. The locking mechanism can use near field communication, Bluetooth, or other means of wireless communication available in the art. Methods for coding the lock operation are known in the art. During normal operation of one embodiment, a user can make purchase through the mobile application, and instructions will be sent through the internet to unlock the container.

In an additional embodiment, the locking mechanism further comprises a back-up disconnected system. If the container is not connected to the internet, a user can still purchase items in the container through the mobile application. In one embodiment, the mobile application provides the user with a code that the user can enter into a keypad on the fridge. The keypad allows the container to be unlocked without the use of the internet or when there are wireless connectivity issues. The locking mechanism of this embodiment comprises sufficient memory storage capacity to allow storage of historical transaction data. Once the locking mechanism is reconnected to the internet, the locking mechanism transmits any and all cached purchases made while the mechanism was off-line. In other embodiments, the back-up disconnected system comprises a keycard reader or another wired mechanism that can be used to unlock the locking mechanism without the use of the Internet, Bluetooth, or other wireless connectivity methods.

In an additional embodiment, the locking mechanism further comprises a QR code that is unique to that particular container system, which can be scanned by a user's mobile device and transmitted through the mobile application to quickly purchase items from the container. Software and hardware used by mobile device to read and transmit QR codes are known in the art.

In a further embodiment, to track inventory, the locking mechanism further comprises mechanisms for detecting when items have been removed from the container and counting the remaining inventory. The mechanism can scan and detect the amount of items that were taken from the container and communicate the quantity to a centralized data system via the internet connectivity. The mechanism can also take photos of the removal of purchased items for added security purposes. The preferred embodiment of these tracking mechanisms is comprised of ocular devices; however, other systems (e.g., weight-based) could be used with similar effects.

The web-based application has separate functionalities for two different categories of users: (1) “owners” of one or more food storage systems that are responsible for maintaining the food storage system and its inventory and for receiving payment for the items purchased from the container system; and (2) “purchasers” who purchase items from the container system.

For owners, the application allows the owner to, for each food storage system controlled by the owner, set the number of items available for a specific food storage system and the prices for each item. The owner can also upload pictures or videos of the items in the container or submit descriptions (including but not limited to descriptions of the food, ingredient lists, and nutritional information) for the users to view when selecting the items for purchase. The application also allows the owner to share the food items and container system information on social media.

In addition to the marketing and listing capabilities, the application also allows owners to monitor inventory and take precautions to maintain the safety of the food items. In one embodiment, the application allows an owner to deactivate a specific locking mechanism, which will leave the container system in a locked state and blocks the application from accepting further orders for that container. In one embodiment, the locking mechanism automatically locks and the application will not accept any additional orders once all inventories in the particular food storage system are sold. In one embodiment, the owner can also set the food storage system to automatically lock and the application to accept no further orders if the “sell-by” or expiration date has passed without all items in the container being sold. In another embodiment, the food storage system further comprises a thermometer and the owner can set the container to automatically lock and the application to accept no further orders if the internal temperature of the container system rose to an unreasonably high temperature remained at that temperature for a period of time that would render the food unsafe to eat. Once the food storage system has been restocked or is otherwise ready for purchases, the owner can activate the food storage system through the application, allowing transactions to occur for that system.

In addition to accepting payment, the application comprises capability to transmit the accumulated revenue to an account, such as a bank account or an online account. The application can also compile the sales data and provide reports of the sales, revenue, most popular items, and other transaction information for the owner.

The application also provides functionality for the users of the system. The “users” are persons who use the application to browse food items available in different container systems and to purchase an item in a container system. For each container, the user can see the descriptions, photographs, and videos posted by owners that describe the contents of the container. To accomplish this, the application allows users to see all locations of all container systems. In one embodiment, the application is also equipped with GPS functionality so that a user can search for and find container systems that are located near that user.

In one embodiment, the application allows the user to scan the QR code for a specific food storage system in order to start the ordering process for that specific system. In a further embodiment, the user can also browse the containers available in the user's area or search for food storage system containing specific items. When a user purchases an item, the payment is processed electronically and, in one embodiment, the payment information is stored for convenient use.

In one embodiment, in addition to real-time purchases, where the user is making the purchase and picking up the item at the same time, the application also allows the user to make advanced purchases and reserve items in a particular container system before arriving at the physical location of the container system. Once all items in the container are sold and picked up or reserved, the locking mechanism automatically locks and the application stops accepting additional purchases.

Once a user has made a payment for instant purchase of an item through the application, the application wirelessly sends an “open lock” command over the internet to the central system, which is then communicated to the specific lock. In the alternative, if a container is disconnected from the internet, the application will provide a code to the user that can be manually entered to open the container system.

In an additional embodiment, when a user has made an advance purchase of an item in a particular food storage system and picks up the item at a later time, the user will be provided with an identification mechanism to use to open the container. In one embodiment, this unlocking mechanism is a QR code. In another embodiment, this unlocking mechanism is an alphanumeric code that is manually entered into a keypad on the locking mechanism. In yet another embodiment, this unlocking mechanism is a key card that can be inserted, swiped, or scanned by the locking mechanism. In a further embodiment, the user can transmit an “unlock” command through the application once the user has arrived at the food storage system that is holding his or her purchased item(s). Those having skill in the art will recognize other alternative mechanisms for unlocking the container.

The user can also use the application to interact with owners and other users. The user can submit reviews for the purchased items, which can optionally be viewable to or hidden from other users. The user can also share items or purchases on social media platforms. The user can save specific purchase as “favorites” or a particular food storage system location as a “favorite.” The application will also generate suggestions for the user of other food items that the user may enjoy based upon that user's purchase and review history.

In one embodiment, the application is capable of integrating with third party applications for meal planning, meal tracking, and other purposes.

This invention was originally designed as a convenience mechanism for small-production chefs and food industry professionals to distribute prepared meals in a convenient manner with minimal delivery infrastructure and for health and food-conscious individuals to conveniently purchase ready-made meals and food products. However, those having skill in the art will recognize that additional and other industries may benefit from this technology.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

1. A method for automated food distribution comprising:
(a) providing a food storage system comprising a container and a locking mechanism, wherein said locking mechanism comprises wireless connectivity capability;
(b) adding one or more food items inside of the container;
(c) locking the container once the food items have been placed inside the container for purchase;
(d) offering the food items stored inside of the container for purchase through one or more electronic means;
(e) purchasing one or more food items stored inside of the container through the electronic means;
(f) sending a command to the locking mechanism to unlock the container, wherein afterwards the container is unlocked by the locking mechanism;
(g) opening the container and collecting the one or more food items that were purchased through the application;
(h) closing the container of the food storage system; and
(i) locking the locking mechanism automatically once the container is closed.

2. The method of claim 1, wherein the container comprises functionality to be temperature controlled.

3. The method of claim 1, further comprising unlocking the locking mechanism through a manual code entered on a keypad connected to the food storage system.

4. The method of claim 1, further comprising storing information about any food items removed from the container while the locking mechanism is not connected to the Internet.

5. The method of claim 1, wherein a number and a type of food items remaining in the food storage system is updated in the application after one or more food items are added or collected from the container.

6. The method of claim 1, wherein the locking mechanism unlocks automatically after the one or more food items are purchased through the application.

7. The method of claim 1, wherein the application ceases offering the food items for purchase once all food items are collected from the food storage system.

8. The method of claim 1, wherein the application ceases offering the food items for purchase if the food items are not purchased prior to the food items' expiration date.

9. The method of claim 1, wherein the application collects payments for the food items and transfers said payments to a bank account.

10. A device for automated food distribution comprising:
(a) a food storage system, comprising:
(i) a container;
(ii) a locking mechanism, comprising coding capable of electronically operating the locking mechanism and wireless connectivity capability; and
(iii) one or more food items stored inside of the container;
wherein the locking mechanism locks the container until a command is received to unlock the container;
(b) one or more of the following electronic applications: a software program, a mobile device application, or a website;
wherein the one or more food items are available for purchase through the application;
wherein the application is configured to receive electronic payments for the food items; and
wherein the application is configured to, upon receipt of payment for one or more food items, send a command to the locking mechanism to unlock the container.

11. The device of claim 10, wherein the container further comprises climate control mechanisms to maintain the food items at a user-selected temperature.

12. The device of claim 10, wherein the locking mechanism further comprises an electronic storage capable of storing information about any sales made while the locking mechanism is not Internet-connected.

13. The device of claim 10, wherein the locking mechanism further comprises a keypad.

14. The device of claim 10, wherein the application further comprises functionality to transfer funds received from purchases of food items to a bank account.

15. The device of claim 10, wherein the application further comprises functionality to cease sales of food items when all food items in the container have been purchased.

16. The device of claim 10, wherein the application further comprises functionality to cease sales of food items when the food items have not been sold prior to the food items' expiration date.

17. The device of claim 10, wherein the container further comprises climate control mechanisms to maintain the food items at a user-selected temperature, and wherein the application further comprises functionality to cease sales of food items when the container has an internal temperature that is unsafe for food storage.

18. The device of claim 10, wherein the locking mechanism further comprises a keypad, and wherein if the locking mechanism is not Internet-connected, the application will provide a code that can be entered on the keypad to unlock the locking mechanism.

19. The device of claim 10, wherein the container further comprises a mechanism to detect the number and type of food items present in the container.

20. The device of claim 10, wherein the application contains functionality to identify the location of one or more food storage systems and the food items contained in each of the one or more food storage systems.
